(19) United States
(12) Patent Application Publication
(10) Pub. No.: US 2015/0121752 A1
(43) Pub. Date: May 7, 2015

(54) Method Of Growth For The Chile Del Monte Chili Plant

(71) Applicant: Inez Pena-Garza, San Antonio, TX (US)

(72) Inventor: Inez Pena-Garza, San Antonio, TX (US)

(21) Appl. No.: 14/535,283

(22) Filed: Nov. 6, 2014

Related U.S. Application Data
(60) Provisional application No. 61/900,981, filed on Nov. 6, 2013.

(51) Int. Cl. A01G 7/00; A01G 7/06; A01G 1/00

(52) U.S. Cl. CPC A01G 7/00; A01G 1/001; A01G 7/06
USPC 47/58.1 FV

(57) ABSTRACT

Disclosed herein is a method directed to growing the Capsicum annuum var. glabriusculum chili plant also known as the Chile Del Monte chile plant. More specifically, the present invention generally relates to a method of growing the Chile Del Monte chili plant through a series of steps starting with the seed of the plant obtained from an existing Chile Del Monte chili plant. In one embodiment the method of growing the chili plant is comprised of five main phases to include seed procurement, heated water treatment, heated light treatment, seed prep for planting, and seed planting and maintenance.

### CROSS-REFERENCE TO RELATED APPLICATIONS

This application claims the benefit under Title 35 United States Code §119(e) of U.S. Provisional Patent Application Ser. No.: 61/900,981; Filed: Nov. 6, 2013, the full disclosure of which is incorporated herein by reference.

### STATEMENT REGARDING FEDERALLY SPONSORED RESEARCH OR DEVELOPMENT

Not applicable

### THE NAMES OF THE PARTIES TO A JOINT RESEARCH AGREEMENT

Not applicable

### INCORPORATING-BY-REFERENCE OF MATERIAL SUBMITTED ON A COMPACT DISC

Not applicable

### SEQUENCE LISTING

Not applicable

### FIELD OF THE INVENTION

The present invention generally relates to a method directed to growing the Capsicum annuum var. glabriusculum chili plant also known as the Chile Del Monte chile plant. More specifically, the present invention generally relates to a method of growing the Chile Del Monte chili plant through a series of steps starting with the seed of the plant obtained from an existing Chile Del Monte chili plant.

### BACKGROUND OF THE INVENTION

Without limiting the scope of the disclosed method, the background is described in connection with a novel method to efficiently and effectively assist growers in growing the Capsicum annuum var. glabriusculum chili plant also known as the Chile Del Monte chili plant through a series of steps starting with the seed of the plant obtained from an existing Chile Del Monte chili plant.

Capsicum annuum var. glabriusculum chili plant is a variety of Capsicum annuum that is native to southern North America and northern South America. Capsicum annuum var. glabriusculum can be found in Texas, Arizona, and Florida in the Southern United States, the Bahamas, the Caribbean, Mexico, Central America, and Colombia. Common names for the plant/shrub include chilitepin, chiltepe, chile tepin, turkey, bird's eye, bird peppers, and Chile Del Monte. The Chile Del Monte chili plant usually grows to a height of around 3.5 feet, but sometimes reach a height of about 10 feet. The tiny chili peppers of the Chile Del Monte chili plant are red to orange-red, usually slightly ellipsoidal, and about 0.31 inches in diameter. The peppers are extremely hot, measuring between 50,000 and 100,000 Scoville units.

Capsicum annuum var. glabriusculum chili plant peppers are used for a variety of food applications such as salsas, dips, and as an ingredient in cooking dishes. As such, the peppers are quite popular.

The challenge has always been in procuring the plant and its' peppers. It is incredibly difficult to propagate the plant and because of the difficulty, you cannot readily purchase the plant or its' peppers. Those that have tried to grow the plant from its' seeds have not had much success and the plant usually dies or there is very little growth. The primary means of procuring the plant and growing it is by locating a naturally occurring plant in the wild. The primary means of propagation of the plant is through natural means. It is often called a bird pepper because the birds will eat the chili peppers. When the seeds pass through the bird's digestive system and is pushed out within their droppings, the excrement acts as a natural coating and fertilizer for the seed to be successful.

Growers or individuals wanting access to the plant or its' peppers locate the plant in the wild and transplant the plant. As expected, this method and approach can be challenging, tedious, and with very limited success. The plant is not readily available and attempts at seed propagation are not very successful.

While all of the aforementioned methods may fulfill their unique purposes, none of them fulfill the need for a practical, effective, and efficient means for growing the Capsicum annuum var. glabriusculum chili plant also known as the Chile Del Monte chili plant.

Therefore, the present invention proposes a novel method to assist rowers in growing the Capsicum annuum var. glabriusculum chili plant also known as the Chile Del Monte chili plant starting with its' seed.

### BRIEF SUMMARY OF THE INVENTION

The present invention, therefore, provides for a method of growing the Chile Del Monte chili plant through a series of steps starting with the seed of the plant obtained from an existing Chile Del Monte chili plant.

In one embodiment the method is comprised of five main phases to include seed procurement, heated water treatment, heated light treatment, seed prep for planting, and seed planting and maintenance.

In another embodiment, the seed procurement phase is comprised of steps directed to obtaining seeds from an existing Chile Del Monte chili plant. In other embodiments, the heated water treatment phase is comprised of steps directed to placing the Chile Del Monte chili plant seeds in heated water sufficient to prepping the Chile Del Monte chili plant seeds for opening. In another embodiment, the heated light treatment phase is comprised of steps directed to placing the Chile Del Monte chili plant seeds under a heat lamp or light to supply sufficient heat to further prep the Chile Del Monte chili plant seeds for opening. In yet another embodiment, the seed prep for planting phase is comprised of steps directed to getting the Chili Del Monte chili plant seeds ready for planting. In another embodiment, the seed planting and maintenance phase is comprised of steps directed to actual planting of the Chile Del Monte chili plant seeds and growing the plant.

In summary, the present invention discloses a method directed to growing the Capsicum annuum var. glabriusculum chili plant also known as the Chile Del Monte chile plant. More specifically, the present invention generally relates to a method of growing the Chile Del Monte chili plant through a series of steps starting with the seed of the plant obtained from an existing Chile Del Monte chili plant.

### BRIEF DESCRIPTION OF THE SEVERAL VIEWS OF THE DRAWINGS

For a more complete understanding of the features and advantages of the present invention, reference is now made to the detailed description of the invention along with the accompanying figures in which:

FIG. 1 is a process flow chart for the method of growth of the Capsicum annuum var. glabriusculum chili plant in accordance with embodiments of the disclosure.

### DETAILED DESCRIPTION OF THE INVENTION

Disclosed herein is a method directed to growing the Chile Del Monte chili plant through a series of steps starting with the seed of the plant obtained from an existing Chile Del Monte chili plant. The numerous innovative teachings of the present invention will be described with particular reference to several embodiments (by way of example, and not of limitation).

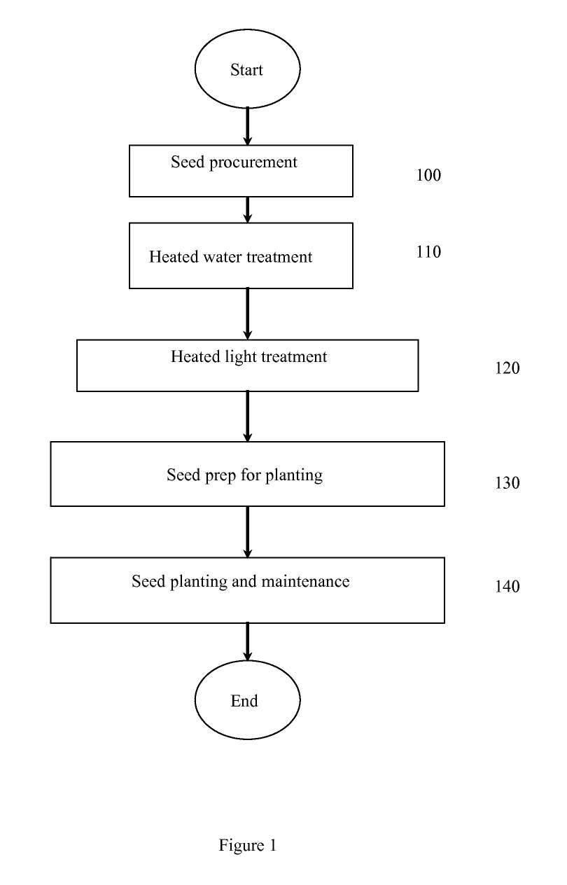

Reference is first made to FIG. 1, a process flow chart for the method of growth of the Capsicum annuum var. glabriusculum chili plant in accordance with embodiments of the disclosure. The described method provides for an effective growth of the Chile Del Monte Chili Plant. Ideally, these steps are performed in a climate similar to the plants' naturally occurring habitat. In one embodiment the method is comprised of five main phases performed in the following order and include seed procurement 100, heated water treatment 110, heated light treatment 120, seed prep for planting 130, and seed planting and maintenance 140.

In an embodiment the seed procurement phase 100 is comprised of the following steps: obtain Chile Del Monte chili pepper seeds from the plant. This is accomplished by taking the peppers preferably fresh from a live plant and opening the peppers up which allows extraction of the seeds from within the peppers.

In an embodiment, the heated water treatment phase 110 is comprised of the following steps: heat a container of water of sufficient quantity to fully submerge the seeds in the water and place the Chili Del Monte chili pepper seeds in the water for a half hour. In another embodiment the seeds are submerged in water in the range of about twenty minutes to forty minutes. In another embodiment, the water is heated and maintained at 175 degrees Fahrenheit. In another embodiment, the water is heated to 175 degrees Fahrenheit and removed from the heating source (or having the heating source turned off) prior to placing the seeds into the container of water. In another embodiment the water is heated to a temperature in the range of 75 degrees Fahrenheit to 200 degrees Fahrenheit before placing the seeds into the water. In another embodiment, a sufficient amount of fertilizer so that the seeds benefit in growth from the fertilizer is placed into the water. In yet another embodiment, the fertilizer amount added is one ounce of Everris concentrated water soluble non liquid form per gallon of water heated. In another embodiment, the Chili Del Monte chili plant seed to water ratio is one half pound of chili plant seeds to one gallon of heated water.

In an embodiment the heated light treatment phase 120 is comprised of the following steps: cover (i.e. place above) the Chili Del Monte chili pepper seeds, water, and in an embodiment fertilizer-water mixture as described in the previous paragraph with an external heat source for fifteen to thirty five hours. In an embodiment, the heat source is a 100 watt bulb placed eighteen inches from the surface of the water level with the seeds six inches deep in the water. In another embodiment, the 100 watt bulb provides a heat source for 24 hours. In yet another embodiment, the heat source provides heat to the seeds in the range of the heat generated from a 75 watt to a 175 watt bulb. That is alternative heat sources may be utilized such as a heat lamp that provides the heat or temperature output equivalent to the range of heat produced by a 75 watt to a 175 watt bulb on Capsicum annuum var. glabriusculum chili plant seeds when the heat source is placed eighteen inches above from the surface of the water level with the seeds six inches deep in the water.

In an embodiment the seed prep for planting phase 130 is comprised of the following steps: remove the Chile Del Monte chili pepper seeds from the water and let dry. In another embodiment, the seeds are allowed to dry for five to twenty minutes before proceeding to the next step. In another embodiment, the seeds are allowed to dry by removing them from the water or water fertilizer solution and placing them on an absorbent material such as a paper towel to air dry. In another embodiment, the seed prep for planting phase 130 is left out.

In an embodiment the seed planting and maintenance phase 140 is comprised of the following steps taking the seeds from the previous step and planting them in soil and watering lightly each day. In another embodiment the seeds are planted in the top layer of the soil not more than a quarter of an inch deep. In another embodiment, the seeds are planted in the range of not deeper than two inches deep down in the soil. In another embodiment the light watering consists of water misting daily sufficiently to moisten the soil and seed. In another embodiment, the seeds are planted in vermiculite as a seed covering or soil amendment. That is when vermiculite is utilized as a seed covering the vermiculite is used instead of the soil and under the same conditions/process described in this paragraph for soil

In another embodiment of the method, only the seed enhancement phases 110 and 120 are utilized as a prep for successfully growing and enhancing the growth rate of the Capsicum annuum var. glabriusculum chili plant. In yet another embodiment of the method, only the seed enhancement phases 110, 120, and 130 are utilized as a prep for successfully growing and enhancing the growth rate of the Capsicum annuum var. glabriusculum chili plant. In another embodiment of the method, the seed enhancement phases 100, 110, and 120 are utilized as a prep for successfully growing and enhancing the growth rate of the Capsicum annuum var. glabriusculum chili plant. In another embodiment of the method, the seed enhancement phases 100, 110, 120, and 130 are utilized as a prep for successfully growing and enhancing the growth rate of the Capsicum annuum var. glabriusculum chili plant.

In brief, the method generally relates to a method directed to growing the Capsicum annuum var. glabriusculum chili plant also known as the Chile Del Monte chile plant.

The disclosed method is generally described, with examples incorporated as particular embodiments of the invention and to demonstrate the practice and advantages thereof. It is understood that the examples are given by way of illustration and are not intended to limit the specification or the claims in any manner.

To facilitate the understanding of this invention, a number of terms may be defined below. Terms defined herein have meanings as commonly understood by a person of ordinary skill in the areas relevant to the present invention. Terms such as “a”, “an”, and “the” are not intended to refer to only a singular entity, but include the general class of which a specific example may be used for illustration. The terminology herein is used to describe specific embodiments of the invention, but their usage does not delimit the disclosed device or method, except as may be outlined in the claims.

It will be understood that particular embodiments described herein are shown by way of illustration and not as limitations of the invention. The principal features of this invention can be employed in various embodiments without departing from the scope of the invention. Those skilled in the art will recognize, or be able to ascertain using no more than routine experimentation, numerous equivalents to the specific method described herein. Such equivalents are considered to be within the scope of this invention and are covered by the claims.

All publications and patent applications mentioned in the specification are indicative of the level of those skilled in the art to which this invention pertains. All publications and patent application are herein incorporated by reference to the same extent as if each individual publication or patent application was specifically and individually indicated to be incorporated by reference.

In the claims, all transitional phrases such as “comprising,” “including,” “carrying,” “having,” “containing,” “involving,” and the like are to be understood to be open-ended, i.e., to mean including but not limited to. Only the transitional phrases “consisting of” and “consisting essentially of,” respectively, shall be closed or semi-closed transitional phrases.

The methods disclosed and claimed herein can be made and executed without undue experimentation in light of the present disclosure. While methods of this invention have been described in terms of preferred embodiments, it will be apparent to those skilled in the art that variations may be applied to the methods and in the steps or in the sequence of steps of the method described herein without departing from the concept, spirit, and scope of the invention.

More specifically, it will be apparent that certain components, which are both shape and material related, may be substituted for the components described herein while the same or similar results would be achieved. All such similar substitutes and modifications apparent to those skilled in the art are deemed to be within the spirit, scope, and concept of the invention as defined by the appended claims.

What is claimed is:

1. A method of growth for the Capsicum annuum var. glabriusculum chili plant comprising the steps of:
applying a heated water treatment to the Capsicum annuum var. glabriusculum chili plant seed(s);
next applying a heated light treatment to said Capsicum annuum var. glabriusculum chili plant seed(s);

2. The method of claim 1, wherein said heated water treatment is comprised of submerging said Capsicum annuum var. glabriusculum chili plant seed(s) in a container of water for about twenty to forty minutes; wherein said water has been heated and is maintained at 175 degrees Fahrenheit.

3. The method of claim 1, wherein said heated water treatment is comprised of submerging said Capsicum annuum var. glabriusculum chili plant seed(s) in a container of water for about twenty to forty minutes; wherein said water has been heated to 175 degrees Fahrenheit prior to submerging said Capsicum annuum var. glabriusculum chili plant seed(s); and wherein said water is allowed to cool by removing or turning off the heating source.

4. The method of claim 2, wherein said time for submerging said Capsicum annuum var. glabriusculum chili plant seed(s) is thirty minutes.

5. The method of claim 3, wherein said time for submerging said Capsicum annuum var. glabriusculum chili plant seed(s) is thirty minutes.

6. The method of claim 2, wherein said water has a sufficient amount of fertilizer added prior to said Capsicum annuum var. glabriusculum chili plant seed(s) submersion so that said Capsicum annuum var. glabriusculum chili plant seed(s) benefit in growth from the fertilizer.

7. The method of claim 3, wherein said water has a sufficient amount of fertilizer added prior to said Capsicum annuum var. glabriusculum chili plant seed(s) submersion so that said Capsicum annuum var. glabriusculum chili plant seed(s) benefit in growth from the fertilizer.

8. The method of claim 6, wherein said fertilizer added is one ounce of Everris concentrated water soluble non liquid form per gallon of said water.

9. The method of claim 7, wherein said fertilizer added is one ounce of Everris concentrated water soluble non liquid form per gallon of said water.

10. The method of claim 2, wherein the following ratio is utilized: one half pound of said Capsicum annuum var. glabriusculum chili plant seeds to one gallon of said water.

11. The method of claim 1, further comprising an initial step of procuring said Capsicum annuum var. glabriusculum chili plant seed.

12. The method of claim 1, further comprising an additional step of prepping said Capsicum annuum var. glabriusculum chili plant seed for planting.

13. The method of claim 11, further comprising an additional step of prepping said Capsicum annuum var. glabriusculum chili plant seed for planting.

14. The method of claim 12, further comprising an additional step of planting and maintaining said Capsicum annuum var. glabriusculum chili plant seed.

15. The method of claim 14, further comprising an initial step of procuring said Capsicum annuum var. glabriusculum chili plant seed.

16. The method of claim 2, wherein said heat light treatment is comprised of applying an external heat source for fifteen to thirty five hours.

17. The method of claim 3, wherein said heat light treatment is comprised of applying an external heat source for fifteen to thirty five hours.

18. The method of claim 16, wherein said heat source provides a heat source on said Capsicum annuum var. glabriusculum chili plant seed(s) equivalent to the heat produced by a 75 watt to a 175 watt bulb placed eighteen inches above from the surface of said water with said Capsicum annuum var. glabriusculum chili plant seed(s) six inches deep in said water.

19. The method of claim 17, wherein said heat source provides a heat source on said Capsicum annuum var. glabriusculum chili plant seed(s) equivalent to the heat produced by a 75 watt to a 175 watt bulb placed eighteen inches above from the surface of said water with said Capsicum annuum var. glabriusculum chili plant seed(s) six inches deep in said water.

20. The method of claim 14, wherein said step of planting and maintaining is comprised of taking said Capsicum annuum var. glabriusculum chili plant seed(s) from the previous step and planting them in soil, vermiculite, or a combination of the two and watering said Capsicum annuum var. glabriusculum chili plant seed(s) lightly each day.
